(19) United States
(12) Patent Application Publication
(10) Pub. No.: US 2025/0190731 A1
(43) Pub. Date: Jun. 12, 2025

(54) INFORMATION PROCESSING APPARATUS AND INFORMATION PROCESSING METHOD

(71) Applicant: SEIKO EPSON CORPORATION, Tokyo (JP)

(72) Inventor: Tetsuya HORII, OKAYA-SHI (JP)

(21) Appl. No.: 18/974,911

(22) Filed: Dec. 10, 2024

(30) Foreign Application Priority Data
Dec. 11, 2023 (JP) 2023-208375

(51) Int. Cl. G06K 15/02; G06F 3/12; H04N 1/00

(52) U.S. Cl. CPC G06K 15/1873; G06F 3/1234; H04N 1/00278

(57) ABSTRACT

An information processing apparatus includes a scan image acquiring section configured to acquire a scan image generated by causing an image forming apparatus including a scanner to scan a first print medium; a code reader configured to read a first code image printed in a predetermined size on the first print medium from the scan image; a level setter configured to set an error correction level of a second code image based on whether the first code image is successfully read; code image generator configured to generate the second code image having the error correction level; and a printing controller configured to adjust a size of the generated second code image to the predetermined size and cause the image forming apparatus to print the second code image having the adjusted size on a second print medium.

The present application is based on, and claims priority from JP Application Serial Number 2023-208375, filed Dec. 11, 2023, the disclosure of which is hereby incorporated by reference herein in its entirety.

### BACKGROUND

### 1. Technical Field

The present disclosure relates to an information processing apparatus and an information processing method.

### 2. Related Art

In recent years, a code image such as a QR code (registered trademark) has been widely used, and various technologies relating thereto have been proposed. For example, JP-A-2009-272796 discloses a technology for reading a two-dimensional code from an image produced by scanning a sheet on which the two-dimensional code has been printed.

JP-A-2009-272796 is an example of the related art.

For example, when the sheet cannot be scanned in high resolution, a clear code image cannot be produced from the image produced by scanning the sheet, and there is therefore a risk of unsuccessful reading of the code image.

### SUMMARY

An information processing apparatus according to an aspect of the present disclosure includes a scan image acquiring section configured to acquire a scan image generated by causing an image forming apparatus including a scanner to scan a first print medium; a code reader configured to read a first code image printed in a predetermined size on the first print medium from the scan image; a level setter configured to set an error correction level of a second code image based on whether the first code image is successfully read; a code image generator configured to generate the second code image having the error correction level; and a printing controller configured to adjust a size of the generated second code image to the predetermined size and cause the image forming apparatus to print the second code image having the adjusted size on a second print medium.

An information processing method according to another aspect of the present disclosure includes acquiring a scan image generated by causing an image forming apparatus including a scanner to scan a first print medium; reading a first code image printed in a predetermined size on the first print medium from the scan image; setting an error correction level of a second code image based on whether the first code image is successfully read; generating the second code image having the error correction level; adjusting a size of the generated second code image to the predetermined size; and causing the image forming apparatus to print the second code image having the adjusted size on a second print medium.

### BRIEF DESCRIPTION OF THE DRAWINGS

FIG. 1 is a block diagram showing an example of the configuration of an information processing system according to an embodiment.

FIG. 2 is a diagrammatic view showing an example of a teaching materials kept in a teaching material database.

FIG. 3 is a diagrammatic view showing an example of the teaching material printed by a printing section of an image forming apparatus.

FIG. 4 is a diagrammatic view showing an example of the teaching material on which answers have been written by a user.

FIG. 5 is a block diagram showing an example of the functional configuration of an information processing apparatus according to the embodiment.

FIG. 6 is a sequence chart showing an example of the procedure of the operation of the information processing system according to the embodiment.

FIG. 7 is a block diagram showing an example of the configuration of a computer.

### DESCRIPTION OF EMBODIMENTS

An embodiment will be described below with reference to the drawings. To clarify the description, omissions and simplifications have been made as appropriate in the description and the drawings below. In the drawings, the same elements have the same reference characters, and no duplicated description of the same elements is made as required.

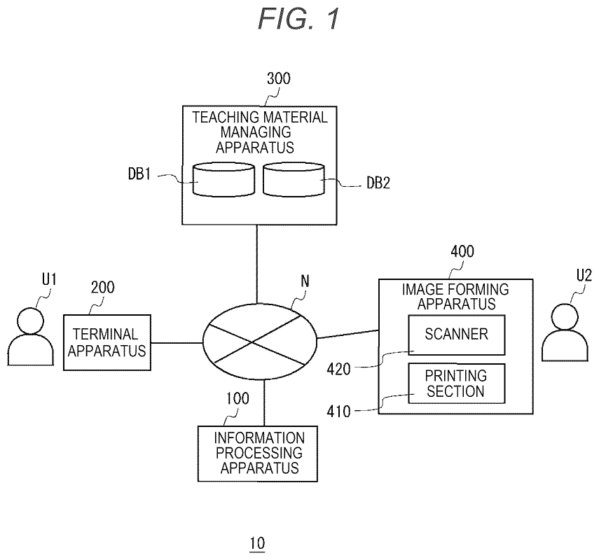

FIG. 1 is a block diagram showing an example of the configuration of an information processing system 10 according to the embodiment. In the example shown in FIG. 1, the information processing system includes an information processing apparatus 100, a terminal apparatus 200, a teaching material managing apparatus 300, and an image forming apparatus 400. The information processing apparatus 100, the terminal apparatus 200, the teaching material managing apparatus 300, and the image forming apparatus 400 are connected to a network N such as the Internet. In the present embodiment, a teaching material such as a test question sheet or a test reply sheet is printed and scanned, but not necessarily, and any document may be printed and scanned by using the information processing system 10.

The terminal apparatus 200 is an apparatus operated by a user U1 and is, for example, a smartphone, a tablet terminal, or a personal computer. The user U1 is a manager who manages distribution of a teaching material to a user U2, and collection of answers written by the user U2 on the teaching material. Specifically, the user U1 is, for example, a teacher who educates the user U2. The user U1 specifies a teaching material to be distributed and a destination to which the teaching material is distributed by using the terminal apparatus 200. Note that a teaching material output from the image forming apparatus 400 is distributed to the user U2, so that the image forming apparatus 400 that is supposed to print the teaching material is specified as a specific destination to which the teaching material is distributed. In the present embodiment, the user U1 notifies via the terminal apparatus 200 the teaching material managing apparatus 300 of a teaching material to be distributed and the image forming apparatus 400 that is supposed to print the teaching material. Note that although FIG. 1 shows one terminal apparatus 200 and one user U1, multiple users U1 can use the information processing system 10. The information processing system 10 can therefore include multiple terminal apparatuses 200.

The teaching material managing apparatus 300 is an apparatus that manages teaching materials. In the present embodiment, the teaching material managing apparatus 300 has a teaching material database DB1, which keeps data on teaching materials. The teaching material managing apparatus 300 further has an answer database DB2, which keeps scan data on a scanned teaching material on which the user U2 has written answers. The teaching material managing apparatus 300 can therefore also be referred to as an apparatus that manages answers written on the teaching material by the user U2. For example, the teaching material managing apparatus 300 may manage the progress of answering, for example, as to which teaching material the user U2 has answered. In the present embodiment, when a teaching material to be distributed and the image forming apparatus 400 that is supposed to print the teaching material are specified via the terminal apparatus 200, the teaching material managing apparatus 300 transmits an instruction to print the teaching material to the information processing apparatus 100. The print instruction contains, for example, data on a teaching material to be distributed (that is, data on document to be printed), information that identifies the image forming apparatus 400 that performs the printing, and additional information. The information that identifies the image forming apparatus 400, that is, information that identifies the hardware of the image forming apparatus 400 is hereinafter referred to as apparatus identification information. The teaching material managing apparatus 300 acquires the data on the teaching material to be distributed from the teaching material database DB1, and transmits the acquired data along with the apparatus identification information and the additional information as the print instruction to the information processing apparatus 100. The additional information refers to information in the form of a code image to be added to a teaching material. That is, the additional information is information to be contained in the code image, in other words, information to be encoded. The teaching material managing apparatus 300 has as the additional information, for example, information that identifies a teaching material to be distributed and information that identifies the user U2 who receives a print of the teaching material. Hereinafter, the information that identifies a teaching material is referred to as teaching material identification information, and the information that identifies the user U2 is referred to as user identification information. Note that the additional information may contain only one of the teaching material identification information and the user identification information. The teaching material managing apparatus 300 receives scan data transmitted from the information processing apparatus 100 and keeps the scan data in the answer database DB2.

The image forming apparatus 400 is an apparatus having a printing function and a scanning function, and is specifically a multifunction machine including a printing section 410 (printer) and a scanner 420. The image forming apparatus 400 is registered as an image forming apparatus in advance in the information processing apparatus 100 to be used to print a teaching material. The image forming apparatus 400 is used by the user U2. The image forming apparatus 400 is provided, for example, at the home of the user U2. FIG. 1 shows one image forming apparatus 400, and the information processing system 10 may include multiple image forming apparatuses 400 when, for example, multiple users U2 use the information processing system 10. The multiple image forming apparatuses 400 may therefore be registered in the information processing apparatus 100. For example, the image forming apparatus 400 may be registered in the information processing apparatus 100 for each of the users U2. When the information processing system 10 includes the multiple image forming apparatuses 400, the multiple image forming apparatuses 400 may be apparatuses of the same model or apparatuses of different models. Model information on the model of each of the image forming apparatuses 400 may be registered in the information processing apparatus 100. The model information is information that identifies the model of the image forming apparatus 400.

The image forming apparatus 400 includes the printing section 410 and the scanner 420, as described above. The image forming apparatus 400 may include a conveyance mechanism that conveys a print medium on which printing is performed by the printing section 410 or a document scanned by the scanner 420. The printing section 410 has a printing function of forming an image on a print medium such as a sheet. For example, the printing section 410 includes a printing engine. The printing engine is a mechanical configuration that prints an image on a print medium with coloring materials. The printing engine may include, for example, an inkjet mechanism that performs printing with ink. The printing engine may instead include, for example, an electrophotographic mechanism that performs printing with toner. The scanner 420 scans a document to generate image data. An image generated by the scanner 420 scanning a document is hereinafter referred to as a scan image. For example, the scanner 420 optically reads a document by scanning the document in a predetermined direction, that is, in a sub-scanning direction by using a light source and a sensor to generate the image data. The image forming apparatus 400 transmits the scan image along with the apparatus identification information, which identifies the image forming apparatus 400, to the information processing apparatus 100.

In the present embodiment, the printing section 410 is used to print a teaching material to which a code image has been added on a print medium. In the present embodiment, the code image is an image of a two-dimensional code having an error correction level selected from multiple error correction levels, and is printed in a predetermined size on a print medium, as will be described later. Note in the present embodiment that a QR code (registered trademark) is used as the code image by way of example, and the code image can be any code image capable of generating a code by using an error correction level selected from multiple error correction levels. The user U2 uses the teaching material printed by the printing section 410. In particular, the user U2 writes answers to questions contained in the teaching material. Specifically, the user U2 writes a handwritten answer on the teaching material, that is, the print medium on which printing has been performed by the printing section 410. The scanner 420 is used to scan the print medium to which the user U2 has written answers.

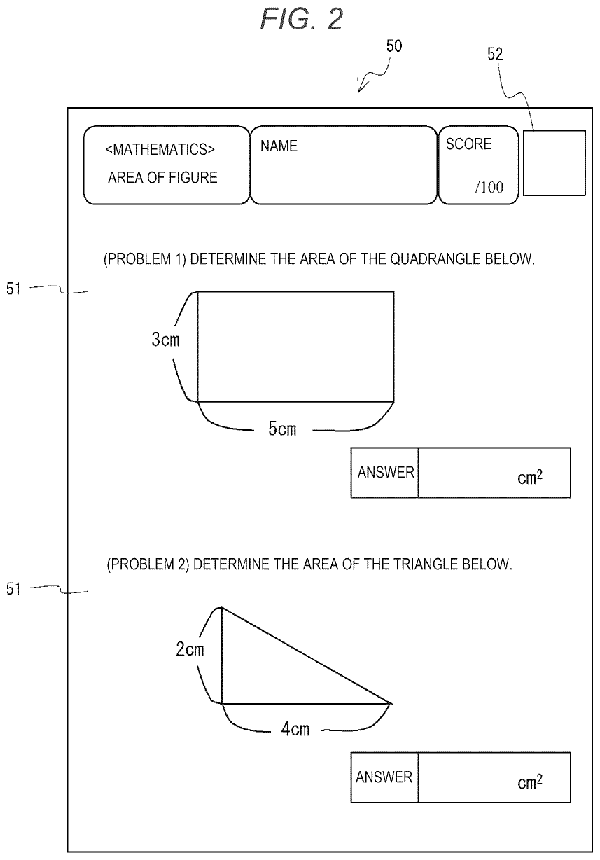

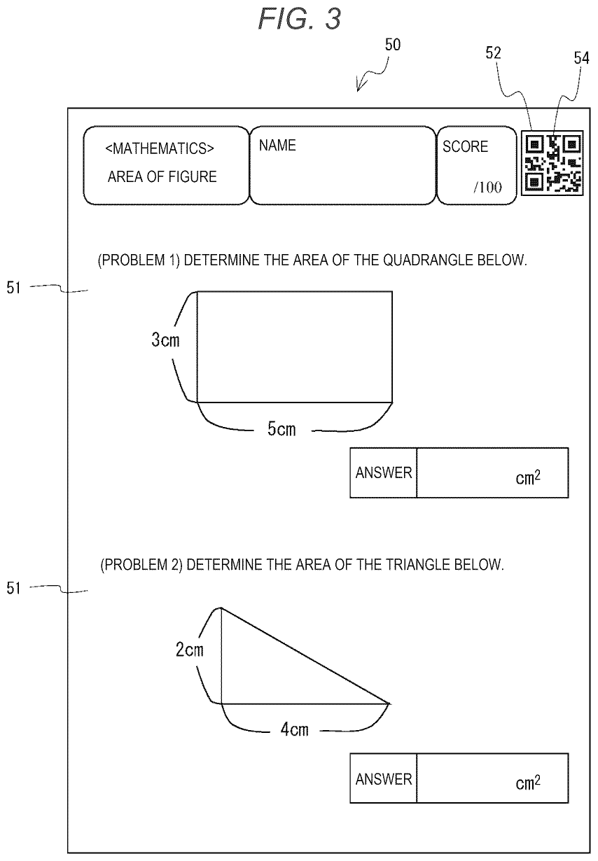

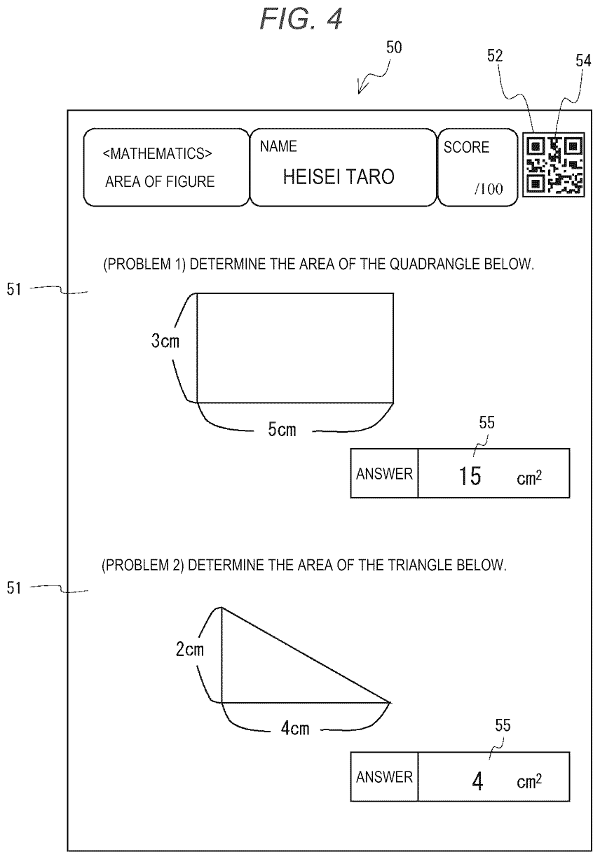

FIG. 2 is a diagrammatic view showing an example of a teaching material 50 kept in the teaching material database DB1. A problem 51 to be solved by the user U2 is printed on the teaching material 50, as shown in FIG. 2. A space 52, which has a predetermined size and to which a code image is added, is provided at a predetermined position on the teaching material 50. Note that the space 52 on the teaching material 50 shown by way of example is surrounded by a frame, but the frame may not necessarily be provided on the teaching material 50. FIG. 3 is a diagrammatic view showing an example of the teaching material 50 printed by the printing section 410 of the image forming apparatus 400. A code image 54 is added to the teaching material 50, as shown in FIG. 3. In more detail, the teaching material 50 to which the code image 54 having a size adjusted to the predetermined size has been added is printed by the printing section 410. The code image 54 is placed in the space 52 of the teaching material 50. Specifically, the code image 54 is enlarged or reduced to the size of the space 52 and placed in the space 52 of the teaching material 50. The code image 54 is generated by using an error correction level selected from multiple error correction levels, as described above. That is, the printed code image 54 is a code image having the selected error correction level. The error correction level indicates the level of capability that enables appropriate decoding of the code image even when a portion of the code image is lost. The higher the error correction level, the greater the number of correctable words, and also the greater the number of error correction codes (Reed-Solomon codes, for example) that need to be contained in the code image. That is, the higher the error correction level, the greater the number of cells that constitute the code image. Note that the cell is a minimum unit block that constitutes a code image. Therefore, when the size of each of the cells that constitute a code image is fixed, the higher the error correction level, the larger the size of the generated code image 54. Therefore, when the size of the generated code image 54 is changed to the size of the space 52 to place the code image 54 in the space 52 having the predetermined size, the higher the error correction level, the smaller the size of the cells that constitute the code image 54. FIG. 4 is a diagrammatic view showing an example of the teaching material 50 on which answers 55 have been written by the user U2. The user U2 writes the answers 55 on the printed teaching material 50, as shown in FIG. 4. The teaching material 50 on which the answers 55 have been written is scanned by the scanner 420, and the scan image is transmitted to the information processing apparatus 100. The higher the error correction level of the code image 54, the smaller the size of each of the cells that constitute the code image 54, as described above. A higher error correction level of the code image 54 to be scanned therefore requires a higher-resolution scanning capability of the scanner 420. In other words, it can be expected that a lower error correction level of the code image 54 to be scanned allows the scanner 420 with a lower performance to read the code image 54. In the present embodiment, occurrence of unsuccessful reading of the code image 54 is reduced by setting the error correction level according to the performance of the scanner 420.

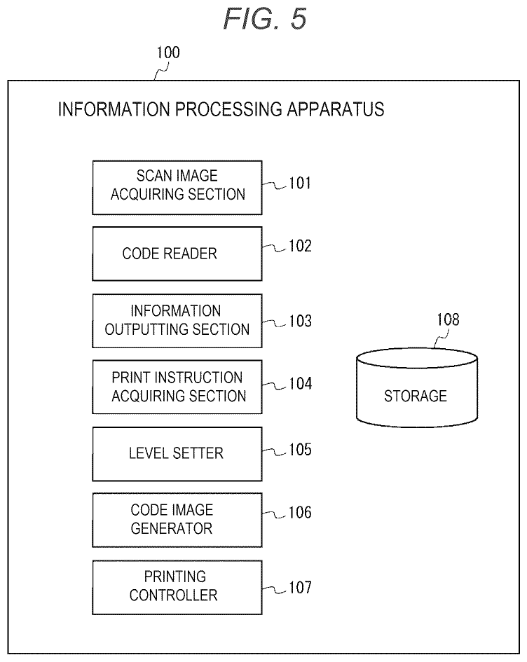

The configuration of the information processing apparatus 100 and processes carried out by the information processing apparatus 100 will next be described. FIG. 5 is a block diagram showing an example of the functional configuration of the information processing apparatus 100. The information processing apparatus 100 includes a scan image acquiring section 101, a code reader 102, an information outputting section 103, a print instruction acquiring section 104, a level setter 105, a code image generator 106, a printing controller 107, and a storage 108, as shown in FIG. 5.

The scan image acquiring section 101 acquires a scan image generated by the image forming apparatus 400 scanning a print medium. That is, the scan image acquiring section 101 acquires a scan image of a print medium (teaching material) having written answers and scanned by the scanner 420. In the present embodiment, a print medium (teaching material) on which a code image has been printed is scanned by the scanner 420. In other words, in the present embodiment, a print medium to be scanned contains a printed teaching material to which a code image has been added. The scan image acquiring section 101 therefore acquires a scan image containing a code image. A code image contained in a scan image is hereinafter referred to as a scan code image. That is, a printed, scanned code image is referred to as a scan code image.

The code reader 102 reads a code image from a scan image (that is, scan code image) acquired by the scan image acquiring section 101. The code reader 102 searches for a scan code image disposed at the predetermined position and detects the scan code image. The code reader 102 then decodes the detected scan code image and acquires decoded data. That is, the additional information is acquired by the decoding. The additional information contains, for example, the teaching material identification information and the user identification information, as described above. The code reader 102 saves information indicating whether the scan code image has been successfully read in the storage 108. The information indicating whether the scan code image has been successfully read is also hereinafter referred to as reading result information. When the scan code image has been detected and successfully decoded, the code reader 102 saves the reading result information indicating that the code image is successfully read in the storage 108, the reading result information being associated with the apparatus identification information that identifies the image forming apparatus 400 having transmitted the scan image. On the other hand, when the scan code image cannot be detected or cannot be decoded, the code reader 102 saves the reading result information indicating that the code image has been unsuccessfully read in the storage 108, the reading result information being associated with the apparatus identification information that identifies the image forming apparatus 400 having transmitted the scan image.

The storage 108 stores information necessary for generation of a code image. Specifically, the storage 108 stores the reading result information described above. The storage 108 stores the reading result information in association with the apparatus identification information that identifies the image forming apparatus 400 having scanned the scan image read to provide the reading result information.

The storage 108 may store a set value of the error correction level. When there are the multiple image forming apparatuses 400, the storage 108 may store the set value of the error correction level for each of the image forming apparatuses 400. When the error correction level is updated based on the reading result information, the storage 108 stores the updated error correction level. In particular, the storage 108 may store the identification information that identifies the image forming apparatus 400 having scanned the scan image and the error correction level set based on the result of reading the scan code image from the scan image, the identification information and the error correction level being associated with each other. The storage 108 may instead store the model information on the model of the image forming apparatus 400 having scanned the scan image and the error correction level set based on the result of reading the scan code image from the scan image, the model information and the error correction level being associated with each other.

When there is only one image forming apparatus 400 registered in the information processing apparatus 100, or the like, the reading result information and the error correction level may be stored in the storage 108 without being associated with the apparatus identification information or the model information.

The information outputting section 103 outputs the scan image acquired by the scan image acquiring section 101 and the decoded data on the scan code image read from the scan image to the teaching material managing apparatus 300. When the code reader 102 unsuccessfully reads the scan code image, the output of the decoded data is omitted. The teaching material managing apparatus 300 keeps the information acquired from the information processing apparatus 100, for example, in the answer database DB2. One or both of the scan image and the decoded data may be referred to as the scan data. As described above, since the scan data is transmitted to the teaching material managing apparatus 300, the teaching material managing apparatus 300 can more appropriately manage the answers written on the teaching material.

The print instruction acquiring section 104 acquires the print instruction to print the teaching material. In the present embodiment, the print instruction acquiring section 104 acquires the teaching material print instruction from the teaching material managing apparatus 300, but may instead acquire the print instruction from the terminal apparatus 200. In the present embodiment, the print instruction contains data on the teaching material to be printed, the information that identifies the image forming apparatus 400 that performs the printing, and the additional information, as described above.

The level setter 105 sets an error correction level of a print code image. The print code image here is a code image printed on a print medium under the control of the printing controller 107, which will be described later. Specifically, in the present embodiment, the print code image is a code image to be printed on a teaching material. In the case of a QR code (registered trademark), there are four known error correction levels, the levels L, M, Q, and H. The level H is the highest error correction level, and the level L is the lowest error correction level.

In particular, the level setter 105 sets the error correction level of the print code image based on whether the scan code image has been successfully read. The level setter 105 sets the error correction level of the print code image, for example, for each image forming apparatus 400. In this case, the level setter 105 refers to the reading result information about the image forming apparatus 400 of interest, and sets the error correction level of a print code image to be printed by using the image forming apparatus 400. Specifically, based on the reading result stored in association with the apparatus identification information that identifies the image forming apparatus 400 that prints the print code image, the level setter 105 sets the error correction level of a print code image to be printed by the image forming apparatus 400. Accordingly, even when the information processing system 10 includes the multiple image forming apparatuses 400, the level setter 105 can set an error correction level suitable for each of the image forming apparatuses 400. In more detail, when a print code image based on the print instruction acquired by the print instruction acquiring section 104 is printed for the first time by a certain image forming apparatus 400, the level setter 105 sets a predetermined error correction level as the error correction level of the print code image to be printed by using the image forming apparatus 400. The predetermined level is hereinafter referred to as a default level. In other words, when no reading result information about a certain image forming apparatus 400 is saved in the storage 108, the level setter 105 sets the default error correction level as the error correction level of a print code image to be printed by using the image forming apparatus 400. The default level is, for example, the highest error correction level (specifically, level H). In contrast, when the reading result information about a certain image forming apparatus 400 is saved in the storage 108, the level setter 105 sets an error correction level of a print code image to be printed by the image forming apparatus 400 based on the reading result information. For example, when the code reader 102 unsuccessfully reads a scan code image from a scan image transmitted from a certain image forming apparatus 400, the level setter 105 lowers the error correction level of a print code image to be printed by using the image forming apparatus 400 from the current set value. For example, the level setter 105 lowers the error correction level by one step. Accordingly, the size of each of the cells of the print code image placed in a space having a predetermined size on a teaching material can be increased. Note that the level setter 105 may lower the error correction level from the current set value when the occurrence rate of unsuccessful reading of a scan code image exceeds a predetermined threshold. For example, when a scan code image has been unsuccessfully read by the image forming apparatus 400 of interest m times or more in the latest n-time reading operations, the level setter 105 lowers the error correction level of a print code image to be printed by the image forming apparatus 400 from the current set value. In the above description, n and m represent natural numbers. The configuration described above allows reduction of a risk of an inappropriate error correction level set in response to unexpected unsuccessful reading.

The level setter 105 saves the set value of the error correction level in the storage 108. The level setter 105 saves the set value of the error correction level in the storage 108, for example, in association with the apparatus identification information that identifies the image forming apparatus 400. The level setter 105 may save the set value of the error correction level in the storage 108 in association with the model information on the model of the image forming apparatus 400.

The code image generator 106 encodes the additional information contained in the print instruction by using the error correction level set by the level setter 105 to generate a print code image. That is, the code image generator 106 generates a print code image having the error correction level set by the level setter 105. In the present embodiment, the print code image contains data used to encode the teaching material identification information and the user identification information on the user U2 who uses the printed teaching material, and may instead contain data used to encode one of the two types of identification information or data used to encode information other than the information described above. Specifically, the code image generator 106 identifies the error correction level associated with the identification information that identifies the image forming apparatus 400 that prints the teaching material and the print code image, and generates a print code image having the error correction level. Note that when a certain image forming apparatus 400 (assumed to be referred to as apparatus A) is used for the printing, the code image generator 106 may generate a print code image by using an error correction level set based on a scan image provided by an image forming apparatus 400 (assumed to be referred to as apparatus B) different from the image forming apparatus 400 (apparatus A). The apparatus A is, for example, the image forming apparatus 400 that has not yet provided a scan image for setting the error correction level. In this case, in the printing performed by the apparatus A, a default level is set by the level setter 105 as the error correction level for the printing performed by the apparatus A. The apparatus A can therefore be also taken as the image forming apparatus 400 in which the default level is set. The apparatus B is the image forming apparatus 400 that provides a scan image for setting the error correction level, and the model of the apparatus B is the same as that of the apparatus A. That is, the apparatuses A and B include the scanners 420 having the same performance. Specifically, when the apparatus A is used to perform the printing, the code image generator 106 may use an error correction level stored in the storage 108 in association with the model information that is the same as the model information on the model of the apparatus A to generate a print code image to be printed by the apparatus A. That is, when the apparatus A is used to perform the printing, the code image generator 106 may use the error correction level set for the printing performed by the apparatus B to generate a print code image. As described above, using the same error correction level between the same models allows use of an appropriate error correction level even when a code image is printed by the image forming apparatus 400 that has not performed the scanning.

The printing controller 107 adjusts the size of the print code image generated by the code image generator 106 to a predetermined size. That is, to place the print code image in a space having a predetermined size, the printing controller 107 changes the size of the generated print code image to the size of the space. Specifically, the printing controller 107 enlarges or reduces the generated print code image in such a way that the size of the generated print code image coincides with the size of the space where the print code image is placed. The size of the generated print code image varies in accordance with the error correction level. Specifically, the higher the error correction level, the larger the size of the generated print code image, as described above. In other words, the lower the error correction level, the smaller the size of the generated print code image. Therefore, when all the generated print code images have the same predetermined size, the lower the error correction level used to generate the print code image, the larger the size of each of the cells that constitute the print code image to be actually placed.

The printing controller 107 causes the image forming apparatus 400 to print the print code image having the adjusted size. Specifically, the printing controller 107 places the print code image having the adjusted size in a predetermined space on a document to be printed, and causes the image forming apparatus 400 to print the document on which the print code image has been placed. In more detail, the printing controller 107 superimposes the print code image on a portion at a predetermined position on a teaching material acquired in response to the print instruction and to be distributed. The printing controller 107 then causes the image forming apparatus 400 specified by the print instruction to print the teaching material on which the print code image has been superimposed. That is, the printing controller 107 causes the image forming apparatus 400 to print the teaching material on which the print code image having the adjusted size has been superimposed. The teaching material containing the print code image is thus printed on a print medium by the image forming apparatus 400. That is, the teaching material to which the print code image has been added is printed on the print medium. Note that the printing controller 107 may cause the image forming apparatus 400 to perform the printing via another apparatus (a server, for example) that manages or controls the printing performed by the image forming apparatus 400, instead of directly instructing the image forming apparatus 400 to perform the printing.

The teaching material with the print code image printed by the image forming apparatus 400 is used by the user U2. Specifically, for example, the user U2 writes answers to questions contained in the teaching material on the teaching material with the printed print code image, as described above. The user U2 then scans the teaching material on which the answers have been written by using the scanner 420 of the image forming apparatus 400. The thus generated scan image is transmitted to the information processing apparatus 100. The code reader 102 then performs the reading, and the reading result information that is the result of the reading is used to update the error correction level. The set value of the error correction level is thus optimized by repeating the printing of a print code image and the reading of a scan code image.

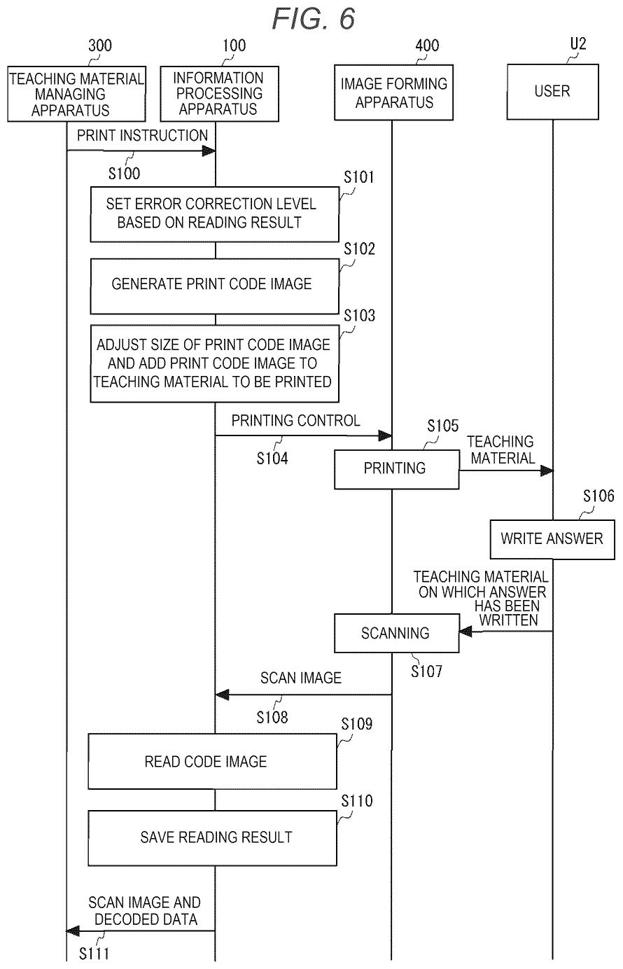

The procedure of the operation of the information processing system 10 will next be described. FIG. 6 is a sequence chart showing an example of the procedure of the operation of the information processing system 10. The procedure of the operation of the information processing system 10 will be described below with reference to FIG. 6.

In step S100, the print instruction acquiring section 104 of the information processing apparatus 100 acquires the print instruction from the teaching material managing apparatus 300. Note that the print instruction does not necessarily need to be acquired from the teaching material managing apparatus 300, and may be acquired, for example, from the terminal apparatus 200, as described above. The acquired print instruction contains the data on a teaching material to be printed, the information that identifies the image forming apparatus 400 that performs the printing, and the additional information.

In step S101, the level setter 105 sets an error correction level of the print code image to be printed by the image forming apparatus 400 specified by the print instruction. Specifically, the level setter 105 sets the error correction level based on the reading result information about the image forming apparatus 400 specified by the print instruction. Note that when there is no reading result information about the image forming apparatus 400 specified by the print instruction, the default level is set as the error correction level.

Thereafter, in step S102, the code image generator 106 encodes the additional information contained in the print instruction by using the error correction level set in step S102 to generate a print code image. Note that when the default level is set as the error correction level in step S101, the code image generator 106 may generate a print code image as described below. That is, the code image generator 106 may generate a print code image by using an error correction level set based on the reading result information on the result of the reading of a scan image provided by another image forming apparatus 400 the model of which is the same as the model of the image forming apparatus 400 specified by the print instruction.

Thereafter, in step S103, the printing controller 107 adjusts the size of the print code image generated in step S102 to a predetermined size. The printing controller 107 then adds the print code image having the adjusted size to a predetermined space of the teaching material to be printed. Thereafter, in step S104, the printing controller 107 carries out a print control process of causing the image forming apparatus 400 to perform the printing. That is, the printing controller 107 causes the image forming apparatus 400 specified by the print instruction to print the teaching material to which the print code image has been added.

Thereafter, in step S105, the image forming apparatus 400 prints the teaching material containing the print code image on a print medium. Thereafter, in step S106, the user U2 uses the printed teaching material. Specifically, the user U2 writes answers to questions contained in the teaching material on the teaching material.

Thereafter, in step S107, the image forming apparatus 400 scans the teaching material on which the answers have been written in step S106 to generate a scan image. Thereafter, the image forming apparatus 400 transmits the scan image generated in step S107 to the information processing apparatus 100, and the scan image acquiring section 101 of the information processing apparatus 100 acquires the scan image.

Thereafter, in step S109, the code reader 102 reads the code image from the scan image acquired in step S108. Thereafter, in step S110, the code reader 102 saves in the storage 108 the reading result information indicating whether the scan code image has been successfully read in association with the identification information that identifies the image forming apparatus 400 having transmitted the scan image. Thereafter, in step S111, the information outputting section 103 transmits the scan image acquired in step S108 and the decoded data on the code image read from the scan image to the teaching material managing apparatus 300. Note that when the code reader 102 unsuccessfully reads the scan code image, the transmission of the decoded data is omitted.

The embodiment has been described above. In the present embodiment, a print code image having an error correction level set based on whether a scan code image has been successfully read is generated, and the size of the generated print code image is adjusted to a predetermined size. A print code image to be suitably read can therefore be printed. That is, an appropriate print code image according to the performance of the scanner 420 of the image forming apparatus 400 can be printed. Occurrence of unsuccessful reading of a code image contained in a scan image can therefore be reduced. In particular, according to the present embodiment, since an appropriate error correction level is automatically set, a manager's or similar person's work of adjusting the set value of the error correction level can be omitted.

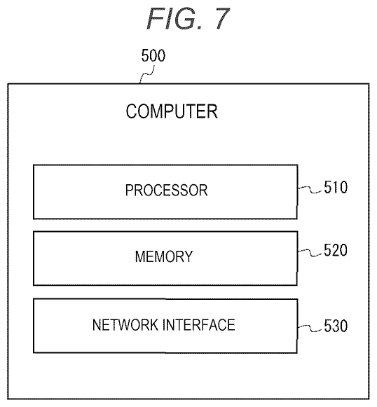

Note that the aforementioned functions (processes) of the information processing apparatus 100 may be realized, for example, by a computer 500 having a configuration below. FIG. 7 is a block diagram showing the configuration of the computer 500. The computer 500 includes a processor 510, a memory 520, and a network interface 530, as shown in FIG. 7.

The network interface 530 is used to perform communication via the network N. The network interface 530 may include, for example, a network interface card (NIC).

The memory 520 is configured, for example, with a combination of a volatile memory and a nonvolatile memory. The memory 520 is used to store a program or the like executed by the processor 510. The storage 108 described above may be realized by a storage device such as the memory 520.

The processor 510 reads the program from the memory 520 and executes the program. The processor 510 thus realizes the functions of the scan image acquiring section 101, the code reader 102, the information outputting section 103, the print instruction acquiring section 104, the level setter 105, the code image generator 106, and the printing controller 107 described above. The processor 510 may, for example, be a microprocessor, a microprocessor unit (MPU), or a central processing unit (CPU). The processor 510 may include multiple processors.

The program includes an instruction group (or software codes) that causes a computer to provide one or more of the functions described in the embodiment when the program is loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or devices based on other memory technologies, a CD-ROM, a digital versatile disc (DVD), a Blu-ray (trademark registered) disc or other optical disc storages, a magnetic cassette, a magnetic tape, a magnetic disk storage or other magnetic storage devices. The program may be transmitted via a transitory computer-readable medium or a communication medium. The transitory computer-readable medium or the communication medium may be, but not limited to, a signal that propagates electrically, optically, acoustically, or in other forms.

The terminal apparatus 200, the teaching material managing apparatus 300, and the image forming apparatus 400 may be configurations of the computer 500. That is, some or all of the aforementioned functions (processes) of the terminal apparatus 200, the teaching material managing apparatus 300, and the image forming apparatus 400 may be realized by the computer 500.

The embodiment has been described above, but the present disclosure is not limited to the embodiment described above and can be changed as appropriate to the extent that the change does not depart from the intent of the present disclosure. For example, a document to be printed is a teaching material in the embodiment described above, and a document other than a teaching material may be specified as the document to be printed. That is, a document to which a code image is added is not limited to a teaching material.

A portion or the entirety of the embodiment described above can also be expressed in the form of additional remarks below, but not necessarily.

### Additional Remark 1

An information processing apparatus including:
a scan image acquiring section configured to acquire a scan image generated by causing an image forming apparatus including a scanner to scan a first print medium;
a code reader configured to read a first code image printed in a predetermined size on the first print medium from the scan image;
a level setter configured to set an error correction level of a second code image based on whether the first code image is successfully read;
a code image generator configured to generate the second code image having the error correction level; and
a printing controller configured to adjust a size of the generated second code image to the predetermined size and cause the image forming apparatus to print the second code image having the adjusted size on a second print medium.

### Additional Remark 2

The information processing apparatus according to the additional remark 1, wherein
the level setter lowers the error correction level from a current set value when the first code image is unsuccessfully read.

### Additional Remark 3

The information processing apparatus according to the additional remark 1, wherein
the level setter lowers the error correction level from a current set value when an occurrence rate of unsuccessful reading of the first code image exceeds a predetermined threshold.

### Additional Remark 4

The information processing apparatus according to any one of the additional remarks 1 to 3, further including
a storage configured to store identification information that identifies the image forming apparatus that scans the scan image and a reading result that is a result of reading the first code image from the scan image, the identification information and the reading result being associated with each other,
wherein the level setter is configured to set the error correction level based on the reading result stored in association with the identification information that identifies the image forming apparatus that prints the second code image.

### Additional Remark 5

The information processing apparatus according to any one of the additional remarks 1 to 3, further including
a storage configured to store model information on a model of the image forming apparatus that scans the scan image and the error correction level set based on a reading result that is a result of reading the first code image from the scan image, the model information and the reading result being associated with each other,
wherein when another image forming apparatus is used to perform the printing, the code image generator is configured to generate the second code image having the error correction level stored in association with model information that is the same as the model information on a model of the other image forming apparatus, and
the printing controller is configured to adjust a size of the generated second code image to the predetermined size and causes the other image forming apparatus to print the second code image having the adjusted size on a second print medium.

### Additional Remark 6

The information processing apparatus according to any one of the additional remarks 1 to 5, wherein
a teaching material to which the first code image is added is printed on the first print medium, and
a teaching material to which the second code image is added is printed on the second print medium.

### Additional Remark 7

The information processing apparatus according to the additional remark 6, wherein
the first code image contains data used to encode at least one of identification information that identifies the teaching material and identification information that identifies a user who uses the printed teaching material, and
the information processing apparatus includes an information outputting section configured to output the scan image and decoded data on the first code image read from the scan image to a teaching material managing apparatus configured to manage an answer written on the teaching material by the user.

### Additional Remark 8

An information processing method including:
acquiring a scan image generated by causing an image forming apparatus including a scanner to scan a first print medium;
reading a first code image printed in a predetermined size on the first print medium from the scan image;
setting an error correction level of a second code image based on whether the first code image is successfully read;
generating the second code image having the error correction level;
adjusting a size of the generated second code image to the predetermined size; and
causing the image forming apparatus to print the second code image having the adjusted size on a second print medium.

What is claimed is:

1. An information processing apparatus including:
a scan image acquiring section configured to acquire a scan image generated by causing an image forming apparatus including a scanner to scan a first print medium;
a code reader configured to read a first code image printed in a predetermined size on the first print medium from the scan image;
a level setter configured to set an error correction level of a second code image based on whether the first code image is successfully read;
a code image generator configured to generate the second code image having the error correction level; and
a printing controller configured to adjust a size of the generated second code image to the predetermined size and cause the image forming apparatus to print the second code image having the adjusted size on a second print medium.

2. The information processing apparatus according to claim 1, wherein
the level setter lowers the error correction level from a current set value when the first code image is unsuccessfully read.

3. The information processing apparatus according to claim 1, wherein
the level setter lowers the error correction level from a current set value when an occurrence rate of unsuccessful reading of the first code image exceeds a predetermined threshold.

4. The information processing apparatus according to claim 1, further comprising
a storage configured to store identification information that identifies the image forming apparatus that scans the scan image and a reading result that is a result of reading the first code image from the scan image, the identification information and the reading result being associated with each other,
wherein the level setter is configured to set the error correction level based on the reading result stored in association with the identification information that identifies the image forming apparatus that prints the second code image.

5. The information processing apparatus according to claim 1, further comprising
a storage configured to store model information on a model of the image forming apparatus that scans the scan image and the error correction level set based on a reading result that is a result of reading the first code image from the scan image, the model information and the reading result being associated with each other,
wherein when another image forming apparatus is used to perform the printing, the code image generator is configured to generate the second code image having the error correction level stored in association with model information that is the same as the model information on a model of the other image forming apparatus, and
the printing controller is configured to adjust a size of the generated second code image to the predetermined size and causes the other image forming apparatus to print the second code image having the adjusted size on a second print medium.

6. The information processing apparatus according to claim 1, wherein
a teaching material to which the first code image is added is printed on the first print medium, and
a teaching material to which the second code image is added is printed on the second print medium.

7. The information processing apparatus according to claim 6, wherein
the first code image contains data used to encode at least one of identification information that identifies the teaching material and identification information that identifies a user who uses the printed teaching material, and
the information processing apparatus includes an information outputting section configured to output the scan image and decoded data on the first code image read from the scan image to a teaching material managing apparatus configured to manage an answer written on the teaching material by the user.

8. An information processing method comprising:
acquiring a scan image generated by causing an image forming apparatus including a scanner to scan a first print medium;
reading a first code image printed in a predetermined size on the first print medium from the scan image;
setting an error correction level of a second code image based on whether the first code image is successfully read;
generating the second code image having the error correction level;
adjusting a size of the generated second code image to the predetermined size; and
causing the image forming apparatus to print the second code image having the adjusted size on a second print medium.
